(19) United States
(12) Patent Application Publication
(10) Pub. No.: US 2018/0014551 A1
(43) Pub. Date: Jan. 18, 2018

(54) Cooked Filled Cheese Product and Method of Making Same

(71) Applicant: Frito-Lay North America, Inc., Plano, TX (US)

(72) Inventors: John Mampra MATHEW, Plano, TX (US); Joshua S. RIVNER, McKinney, TX (US)

(21) Appl. No.: 15/211,327

(22) Filed: Jul. 15, 2016

(51) Int. Cl. A23C 19/09

(52) U.S. Cl. CPC A23C 19/0908; A23P 30/25; A23C 19/0912

(57) ABSTRACT

A cooked filled cheese product comprises an unbattered processed cheese coating around a filling. The filled cheese product is unbattered and unbreaded and retains its shape and filing throughout cooking, freezing, and/or subsequent reheating prior to consumption. The method of making the cheese product comprises cold extrusion of the cheese and filling, followed by cooking without any batter or breading resulting in a fried product having substantially no oil uptake. The cooking step may comprise frying to produce a fried filled cheese product.

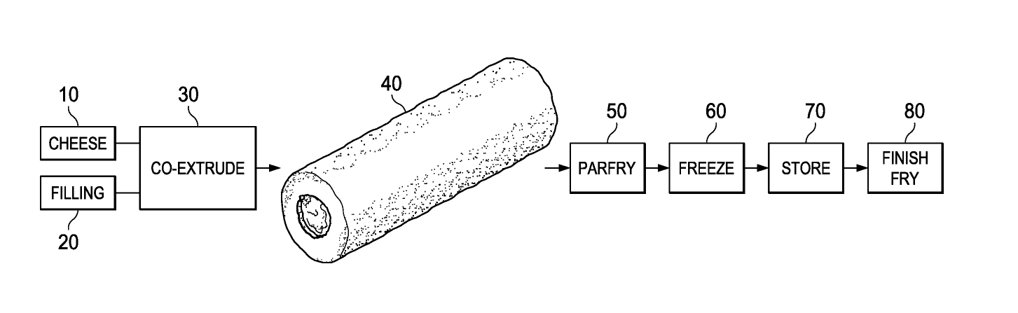

### BACKGROUND OF THE INVENTION

### Technical Field

The present invention relates to a method for making a filled cheese product; and, in particular, a method of making a filled cheese product with a cooked outer cheese coating free of batter and breading, with optional refrigeration or freezing steps for subsequent re-heating for consumption.

### Description of Related Art

It is difficult to maintain dairy flavor throughout cooking processes requiring heat. While seasonings may be able to survive a fryer or oven, dairy is not.

DE 102 27 747 discloses an edible cheese composition with a center, the outer cheese composition consisting of a cheese made from milk using rennet but without the use of lactic-acid bacterial cultures. The cheese composition is a halloumi cheese or a similar cheese with a pH greater than 6.

US Patent Publication No. 2008/0268104 discloses a filled cheese product that is pan-fried from frozen. A cheese mixture forms the outer envelope of the product and is made solely of a natural cheese mixture in the form of a specific amount of Mozzarella combined with a specific amount of Emmental cheese (a variety of Swiss cheese). Starch is combined with the cheese mixture to assist in shape retention at high temperature.

U.S. Pat. No. 6,632,466 discloses a method of co-extruding a solid casing coating with at least one stuffing. Hot co-extrusion is used for cheese casing materials, which must contain an added whey protein source to provide the cheese with the ability to be formed by co-extrusion.

It is desirable to obtain a dairy product with a flavor and shape able to survive the hot temperatures of a cooking step. There is also a need for a cheese product free of batter and breading such that oil absorption from cooking step(s) is avoided.

### SUMMARY OF THE INVENTION

Below is a simplified summary of this disclosure meant to provide a basic understanding of some aspects of the invention. This is not an exhaustive overview and is not intended to identify key or critical elements of the invention or to delineate the scope of the invention. Its sole purpose is to present some concepts in a simplified form as a prelude to the more detailed description below.

In one aspect, disclosed herein is a method of making a food product comprising the steps of: co-extruding a cheese material together with a filling material to form a co-extruded food product comprising an edible core of the filling material and an outer coating of the cheese material, wherein the cheese material is a processed cheese free of starch, the co-extruded food product comprising an oil content; and cooking the co-extruded food product to form an unbattered cooked cheese product comprising the oil content of the co-extruded food product. In one embodiment, the cooking step comprises frying in oil. In any embodiment, the processed cheese is a pasteurized processed cheese. In any embodiment, the method further comprises a cutting step prior to the cooking of the co-extruded food product to form a plurality of unbattered cooked cheese products. In an embodiment with any of the above limitations, the cheese material comprises a pH of less than 6. In an embodiment with any of the above limitations, the cheese material comprises a pH of between about 5 and less than 6. In any of the above embodiments, the co-extruded food product comprises a shape substantially identical to that of the unbattered cooked cheese product. In any of the above embodiments, the co-extruded food product comprises a shape substantially identical to that of the unbattered cooked cheese product. In any of the above embodiments, the method comprises the step of freezing the unbattered cooked cheese product to produce a frozen filled cheese product for subsequent re-heating. In any embodiment producing the frozen filled cheese product, the unbattered cooked cheese product is frozen to less than or about −10° F. In any of the above embodiments, the cooking step of the method comprises frying to an internal core temperature of about 140° F. In any of the above embodiments, the co-extruding step is performed at a temperature of less than about 100° F.

In a second aspect of the present disclosure, a fried cheese product comprises a combination of an unbattered processed cheese material free of starch and a filling within the processed cheese, wherein the oil content of the fried cheese product post-frying is substantially the same as the combination prior to frying. That is, the fried cheese product comprises an oil content that is substantially the same as the oil content of the combination of the unbattered cheese and the filling prior to frying. In one embodiment, the fried cheese product consists of the processed cheese material and the filling. In any embodiment, the processed cheese is a pasteurized processed cheese. The fried cheese product is free of breading in any embodiment. The outer cheese coating comprises a pH of no more than 6 in any of the above embodiments. The fried cheese product comprises a tubular shape in any embodiment. In any of the above embodiments of the product, the fried cheese product comprises an internal core temperature of about 140° F. In any of the above embodiments of the product, the fried cheese product comprises a temperature of less than or about −10° F.

Other aspects, embodiments and features of the invention will become apparent in the following written detailed description.

### BRIEF DESCRIPTION OF THE DRAWINGS

The novel features believed characteristic of the invention are set forth in the appended claims. The invention itself, objectives, and advantages thereof will be best understood by reference to the following detailed description of illustrative embodiments when read in conjunction with the accompanying drawings, wherein the:

FIGURE is a flow chart of one embodiment of the present disclosure.

### DETAILED DESCRIPTION

Unless otherwise specified, all percentages, parts and ratios as used herein refer to percentage, part, or ratio by weight of the total. Unless otherwise clear from the context, all numerical values provided herein are modified by the term “about.” The term “about” as used herein refers to the precise values as indicated as well as to values that are within statistical variations or measuring inaccuracies. The term “about” as used herein refers to the precise values as indicated as well as to values that are within statistical variations or measuring inaccuracies. “About” can be understood, for example, as within 0.5%, 0.1%, 0.05%, or 0.01% of the stated value. The terms “a,” “an,” and “the” also refer to “one or more” or “at least one” unless expressly specified otherwise.

The FIGURE indicates a flow chart of one embodiment of the method disclosed herein. A cheese material 10 and a filling material 20 are simultaneously placed into a co-extruder 30 to form a co-extruded food product 40 comprising an edible core of the filling material and an outer coating or casing of the cheese material. The cheese material is a pasteurized processed cheese free of starch. The co-extruder equipment used may comprise any co-extrusion system capable of cold extrusion processes at temperatures of less than 100° F. In one embodiment, cold extrusion is performed at temperatures of between about 40° F. to about 100° F. Following co-extrusion 30, the co-extruded food product comprises a substantially tubular or tubular shape with the cheese material 10 forming an outer casing around the filling material 20. As used herein, “tubular” means long or elongated structures with a filling, and may comprise any number of shapes around the filling including cylindrical, triangular, or square shaped cheese materials reflective of the die from which it is extruded. In one embodiment, the filling material 20 remains visible on either end of the tubular shape, in the center or core within the cheese material 10.

As used herein, a processed cheese material is a prepared, enzyme-modified cheese blend made from a natural cheese and any number of other components, including an emulsifying salt and flavor, the cheese blend formulated to produce a cheese material with substantially no melting properties at temperatures of up to 180° F. That is, the processed cheese is one that has the ability to retain its co-extruded shape throughout cooking processes at internal temperatures of up to about 180° F. In one embodiment, the processed cheese comprises sufficient phosphates to produce a cheese with highly restricted melt properties. The processed cheese material may also be frozen and stored for subsequent re-heating without losing its original co-extruded shape.

In one embodiment, the cheese material may contain sufficient phosphates to change the degree of melt to one that is highly restricted such that shape is retained as described above. In one embodiment, at temperatures of about 70° F., the cheese material comprises a pH of less than or about 6. In one embodiment, the pH of the cheese material ranges from about 5.3 to no more than 6.0. In one embodiment, the moisture of the cheese material is no more than 42.0%. In one embodiment, the moisture of the cheese material is no more than 43.0%. In one embodiment, the moisture of the cheese material is no more than 44.0%. In one embodiment, the moisture of the cheese material is no less than about 32%. In one embodiment, the moisture of the cheese material is between about 32% and about 44%. In one embodiment, the cheese material comprises a fat content of greater than 27%. However, the fat content may vary in other embodiments so long as the material retains its shape after cooking or frying. Fat content of the cheese material may vary according to the desired flavor of the cheese material but should not exceed about 45%. In one embodiment, the cheese material comprises salt, the salt percentage by weight being no more than about 2.5% total salt.

Table 1-3, below, depict examples of different flavors and characteristics of cheese materials successfully used during test runs of the methods and products described herein. One skilled in the art will recognize that any number of additional components can be added to achieve the desired flavor so long as the cheese does not melt as described above, including without limitation one or more of enzymes, milk proteins, cream, cultured milk, sodium phosphates, whey, preservatives, color, lactic acid, and flavors such as, for example, chili peppers, cumin, paprika, garlic powder, cumin powder, tomato powder and other spices.

TABLE 1
Pasteurized Processed Sharp Cheddar Cheese

| Component | Value | |
|---|---|---|
| Moisture | 32-42% | |
| Fat | >27% (dry fat basis) | |
| pH | 5.3-6.0 | |
| Total Salt | 1.7-2.3% | |
| Total Carbohydrates* | 2.7 | grams |
| Calories* | 359.8 | kcal |
| Total fat* | 28.9 | grams |
| Sugars* | 1.9 | grams |
| Protein* | 22.3 | grams |
| Sodium* | 1496.6 | mg |

*Based on 100 g

Based on a 100 gram portion, the pasteurized processed sharp cheddar cheese may comprise less than 360 kcal, less than 30 grams total fat, less than 3 grams total carbohydrates, less than 2 grams sugars, about 22 grams of protein and less than 1500 mg sodium.

TABLE 2
Pasteurized Processed Mozzarella-style Cheese

| Component | Value | |
|---|---|---|
| Moisture | 32-44% | |
| Fat | ≧43% (dry fat basis) | |
| pH | 5.4-6.0 | |
| Salt | 1.8-2.3% | |
| Total Carbohydrates* | 2.0 | grams |
| Calories* | 352.7 | kcal |
| Total fat* | 28.1 | grams |
| Sugars* | 0.9 | grams |
| Protein* | 23.2 | grams |
| Sodium* | 1507.3 | mg |

*Based on 100 g

Based on a 100 gram portion, the pasteurized processed mozzarella-style cheese may comprise less than 360 kcal, less than 30 grams total fat, about 2 grams of total carbohydrate, less than 1 gram of sugars, about 23 grams of protein, and about 1500 mg of sodium.

TABLE 3
Pasteurized Process Cheese Product with
Jalapeno Peppers and Nacho Seasoning

| Component | Value | |
|---|---|---|
| Moisture | 32-42% | |
| Fat | ≧27% (dry fat basis) | |
| pH | 5.3-6.0 | |
| Salt | 1.7-2.3% | |
| Total Carbohydrates* | 2.6 | grams |
| Calories* | 355 | kcal |
| Total fat* | 28.4 | grams |
| Sugars* | 1.5 | grams |
| Protein* | 22.3 | grams |
| Sodium* | 1521.9 | mg |

*Based on 100 g

Based on a 100 gram portion, the pasteurized processed mozzarella-style cheese may comprise less than 360 kcal, less than 30 grams total fat, less than 3 grams of total carbohydrate, less than 2 grams of sugars, about 22 grams of protein, and about 1500 mg of sodium.

As used herein, the terms “filling” and “filing material” are used interchangeably. The filling material comprises a formulation free of water, instead using vinegar slowly added to the dry ingredients such that the pre-blend components blend with the vinegar to form a filling with a pH of less than 4.6. In one embodiment, the filling material comprises a pH of about 4.0. In one embodiment, about 4% vinegar is used in the total filling formulation. Below Tables 4-5 depict a sample formulations. During test runs, the components of the filling material were blended vigorously with high speed and then refrigerated until co-extrusion.

TABLE 4
Marinara filling example formulation

| Component | % |
|---|---|
| Tomato concentrate 0.06″ 26% | 1.02 |
| Olive oil | 87.7 |
| Vinegar, 120 grain | 5 |
| Sugar | 4 |
| Salt | 1 |
| Onion powder | 0.5 |
| Garlic powder | 0.4 |
| Oregano & Basil | 0.2 |
| Xantham gum | 0.1 |
| Fiber | 0.08 |

TABLE 5
Black bean filling formulation example

| Component | % |
|---|---|
| Black beans, refried ribbon extruded | 18 |
| Jalapeno puree | 6 |
| Tomato concentrate 26%, 0.06 | 4 |
| Enchilada seasoning | 2.5 |
| Modified tapioca starch | 1 |
| Cayenne pepper | 0.15 |
| White vinegar, 120 grain | 0.1 |
| Water | 69.25 |

Following formation of the co-extruded food product, the co-extruded food product is subjected to cooking to an internal core temperature of about 140° F. In one embodiment, the cooking step comprising frying in an oil. Returning to the discussion of the embodiment of the FIGURE, the co-extruded food product 40 may be subjected to par-frying 50. In one embodiment, the co-extruded food product is fried for about 30 seconds at an oil temperature of about 350° F. In other embodiments, the co-extruded food product may be baked so long as the internal core temperature reaches about 140° F. Following par-frying 50, the fried cheese product retains the co-extruded shape, having the filling within the cheese casing with substantially no melting and substantially the same oil content as the product prior to cooking or frying. That is, during and following frying steps, there is 0% oil uptake or 0% oil retention stemming from the frying oil. As used herein, “substantially the same” means a difference of less than 1%. In one embodiment, the oil content of the fried product is identical to that of the pre-fried product, or the product of the cheese material with its filling prior to frying. The par-fried food product may then be frozen 60 to temperatures of −10° F. and stored 70 until consumption is desired, at which point, the food product may be finish fried 80.

In one embodiment, the co-extruded food product 40 may be subjected to a cutting step prior to cooking or par-frying 50, for example, as in the FIGURE. The cutting step may provide for a plurality of snack-sized or bite-sized products prior to cooking or prior to freezing. In test runs, to obtain snack-sized portions, the co-extruded food product was cut to a length of about 3.5 inches, with ends left open such that the filling remained visible on either end. Embodiments in which the ends are sealed such that the filling is not visible within the cheese casing are also possible.

During test runs, several different cheeses were tested using a Vemag® Robot HP E series from Reiser® to extrude the product. Specifically, a HP-30 for the cheese material and a HP-3 for the filling material with a standard co-extruder nozzle. A screw speed +2% outer and 2.8% inner was used. The die used for tubular products comprised an OD of 20 mm, and an ID of 9.5 mm. In some test runs, a triangular die with dimensions of 30 mm×30 mm×30 mm was used, with the same length and screw speed. The cooked cheese product comprises substantially the same shape as the die used for co-extrusion. In one embodiment, the cooked cheese product comprises a tubular shape with a diameter of about 20 mm. In another embodiment, the cooked cheese product comprises a triangular shape with dimensions of about 30 mm×30 mm×30 mm.

In one embodiment, the cheese to filling ratio is between about 45:55 and 85:15. In one embodiment, the cheese product comprises between about 45% and about 85% cheese material, with the remaining portion being the filling. In one embodiment, the cheese product comprises between about 50% and about 85% cheese material. In one embodiment, the cheese product comprises between about 75% and about 85% cheese material. In fried embodiments, the fried cheese product comprises significantly less oil compared to a typical cheese product with a batter coating comprising carbohydrates. That is, upon frying, the product described herein experiences 0% oil retention or uptake from the frying oil.

The method and product illustratively disclosed herein suitably may be practiced in the absence of any element or limitation not specifically disclosed herein. The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, any combination of the above-described elements in all possible variations thereof is encompassed by the invention unless otherwise indicated herein or otherwise clearly contradicted by context.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

1. A method of making a food product comprising the steps of:
co-extruding a cheese material and a filling material to form a co-extruded food product comprising an edible core of the filling material and an outer coating of the cheese material, wherein the cheese material is a processed cheese free of starch, the co-extruded food product comprising an oil content; and
cooking the co-extruded food product to form an unbattered cooked cheese product comprising substantially the same oil content as the co-extruded food product prior to cooking.

2. The method of claim 1 further comprising a cutting step prior to the cooking of the co-extruded food product to form a plurality of unbattered cooked cheese products.

3. The method of claim 1 wherein the cheese material comprises a pH of less than 6.

4. The method of claim 1 wherein the cheese material comprises a pH of between about 5 and less than 6.

5. The method of claim 1 wherein the co-extruded food product comprises a shape substantially identical to that of the unbattered cooked cheese product.

6. The method of claim 1 comprising the step of freezing the unbattered cooked cheese product to produce a frozen filled cheese product for subsequent re-heating.

7. The method of claim 6 wherein the unbattered cooked cheese product is frozen to less than or about −10° F.

8. The method of claim 1 wherein the cooking step comprises frying to an internal core temperature of about 140° F.

9. The method of claim 1 wherein the co-extruding step is performed at a temperature of less than about 100° F.

10. A fried cheese product comprising an oil content and a combination of an unbattered processed cheese free of starch and a filling within the processed cheese, wherein the oil content of the fried cheese product is substantially the same as the combination prior to frying.

11. The fried cheese product of claim 10 free of breading.

12. The fried cheese product wherein the cheese comprises a pH of no more than 6.

13. The fried cheese product of claim 10 comprising a tubular shape.

14. The fried cheese product of claim 10 comprising an internal core temperature of about 140° F.

15. The fried cheese product of claim 10 comprising a temperature of less than −10° F.
